(19) United States
(12) Patent Application Publication
(10) Pub. No.: US 2020/0324845 A1
(43) Pub. Date: Oct. 15, 2020

(54) ROLLER BOARD

(71) Applicant: Pascher + Heinz GmbH, Munchen (DE)

(72) Inventors: Reinhard Pascher, Salmdorf (DE); Tao Schirrmacher, Munchen (DE); Christian Bratsch, Salzburg (AT)

(73) Assignee: Pascher + Heinz GmbH, Munchen (DE)

(21) Appl. No.: 16/845,620

(22) Filed: Apr. 10, 2020

(30) Foreign Application Priority Data
Apr. 10, 2019 (DE) 10 2019 002 632.2

(51) Int. Cl. B62K 5/08; B62K 3/00; B62K 5/05

(52) U.S. Cl. CPC B62K 5/08; A63C 17/011; B62K 5/05; B62K 3/002

(57) ABSTRACT

The roller board having a footboard and two front wheels mounted on a front axle can be steered in that the front axle is connected to the footboard pivotable about an axis perpendicular to the plane of travel. The front axle is resiliently coupled to the footboard in the direction of rotation.

### REFERENCE TO RELATED APPLICATION

This application claims priority to German application 10 2019 002 632.2, filed Apr. 10, 2019, the entire disclosure of which is incorporated herein by reference.

### FIELD OF THE INVENTION

The invention relates to a roller board. In particular, the invention relates to a steering device for such a roller board, which is generally also referred to as a skateboard. According to the invention, however, scooters can also be included.

### BACKGROUND OF THE INVENTION

DE 20 2008 006 764 U1 describes a roller board having a grip element as steering means for rollers that are arranged so as to be rotatable about a steering axis perpendicular to their axle when the roller board experiences a steering movement.

DE 20 2015 0153 05 U1 illustrates a roller board having a deck that acts as a standing surface, as well as having two tilt-activated steering axles and four wheels.

### SUMMARY OF THE INVENTION

The object of the invention is to provide a roller board having a simplified steering device that also enables very small radii of curvature, can be actuated with little effort, and returns smoothly and dynamically after deflection to the starting position for straight-ahead travel.

This object is achieved by the features specified in claim 1. Advantageous embodiments and refinements of the invention can be found in the subclaims.

### BRIEF DESCRIPTION OF THE FIGURES

The invention is explained in more detail below using exemplary embodiments in conjunction with the drawings. In the drawings:

FIG. 1 illustrates a roller board having a steering device;

FIG. 2 provides a view obliquely from above of essential elements of the steering device;

FIG. 3 illustrates a section through the steering device along the line A-A in FIG. 2;

FIG. 4 is an exploded view of the steering device according to another exemplary embodiment of the invention.

### DETAILED DESCRIPTION OF PREFERRED EMBODIMENTS

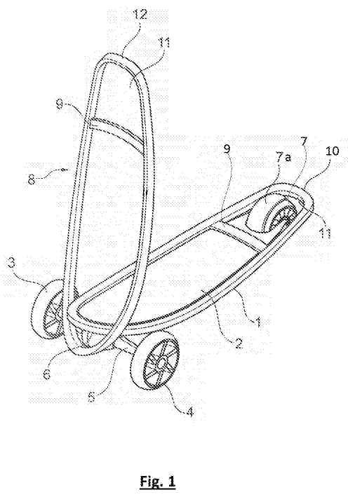

The roller board in FIG. 1 has a frame 1 to which a footboard 2 is attached. Two front wheels 3 and 4 are mounted on the frame 1 by means of a common front axle 5 that is attached to the frame 1 or footboard 2 via a pivot bearing 6. As their name suggests, the two front wheels 3 and 4 are disposed in the front region of the roller board in relation to its normal direction of travel.

A single rear wheel 7 is attached to the rear region of the frame 1 and is provided here with a wheel brake 7a. A pivotable bracket 8 is attached to the front region of the roller board and can be pivoted between an essentially vertical position, which is shown in FIG. 1, and an essentially horizontal position. The bracket 8 can be fixed in both positions, for example by means of a spring-loaded locking pin that can snap into assigned holes.

In the embodiment in FIG. 1, the bracket 8 is an approximately elliptical closed bracket in plan view, which in its rear region also has a cross strut 9 that rests on the frame 1 and/or footboard 2 when the bracket 8 is in the substantially horizontal position.

In the exemplary embodiment in FIG. 1, the frame 1 is extended rearward beyond the rear wheel 7, so that the rear end 10 there is at a distance from the rear wheel 7, forming a free space 11 for a grip region. The bracket 8 can then optionally be long enough that its rear end 12 is congruent with the rear end 10 of the bracket 1 or even projects beyond the rear end 10, so that the free space 11 forming the grip region is disposed between the two ends 10 and 12.

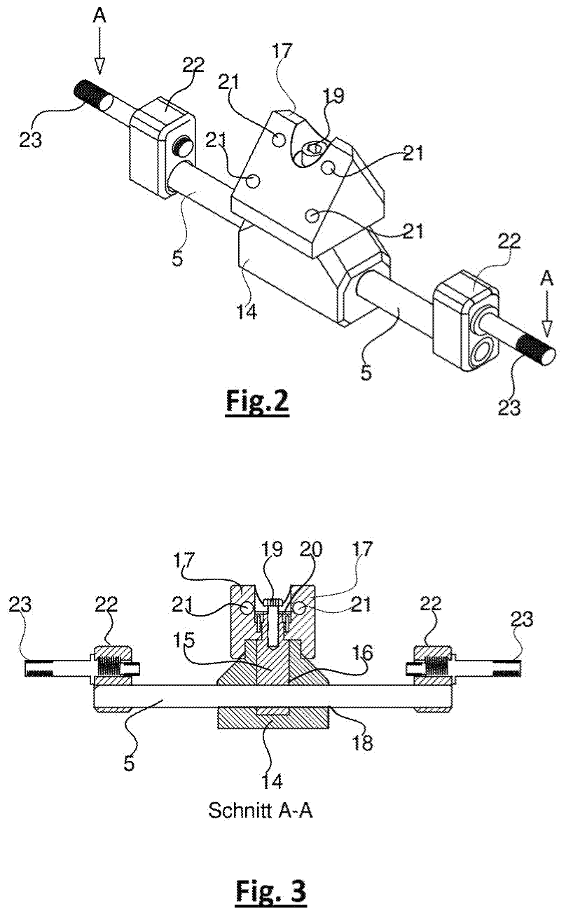

FIG. 2 shows the steering device and parts of the front axle 5 seen obliquely from above in plan view. The pivot bearing 6 has a holding block 14 through which the front axle 5 is inserted. A pivot pin 15 (FIG. 3) is held in the holding block 14, runs perpendicular to the front axle 5, and has an opening 16 through which the front axle 5 is inserted. A lower end of the pivot pin 15 is thus fixed on the front axle 5, so that this end cannot rotate relative to the holding block 14.

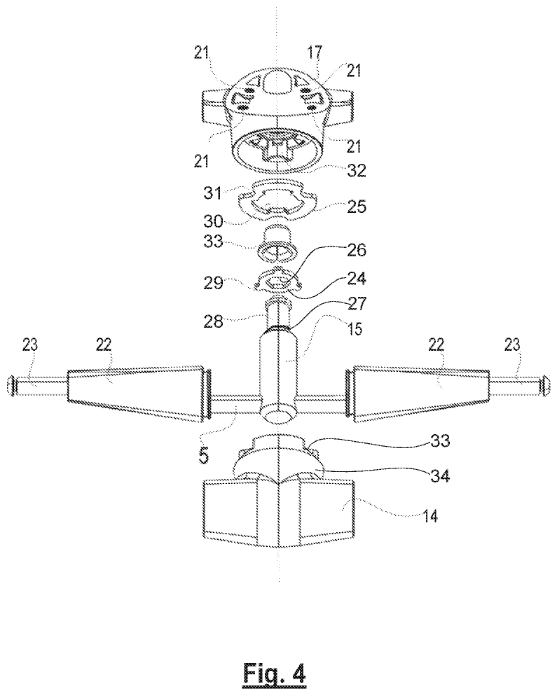

The sectional view in FIG. 3 shows that an upper end of the pivot pin 15 projects out of the holding block 14 and into a fastening block 17 that forms a part of the pivot bearing 6 and can be rotated relative to the holding block 14 about the axis of the pivot pin 15. In a preferred exemplary embodiment of the invention, described in more detail below in connection with FIG. 4, the holding block 14 is resilient, for example, is made of rubber-elastic material, and provides for an automatic return to straight-ahead travel after cornering. In this variant, the pivot pin 15 is rigid.

In another exemplary embodiment of the invention, the pivot pin 15 is made of a resilient material, while the holding block 14 is made of a rigid material. The upper end of the pivot pin 15 is securely and non-rotatably connected to the fastening block 17.

The pivot pin 15 has a larger diameter in the region disposed within the holding block 14 than in the region disposed within the fastening block 17. In the upper region of the holding block 14, the diameter thereof is smaller than in the lower region and acts as a guide for a segment of the fastening block 17, resulting in a pivot bearing in which the pivot pin 15 forms the axis of rotation.

The rotationally fixed connection between the pivot pin 15 and the front axle 5 is accomplished in that the front axle 5 is inserted through a hole 16 in the pivot pin 15. Correspondingly, the holding block 14 also has a hole 18 that is aligned with the hole 16 of the pivot pin 15, so that the front axle 5 can be inserted through both holes 16 and 18.

In this exemplary embodiment, the pivot pin 15 is attached to the holding block 14 by means of a screw 19 that is screwed into the fastening block 17 and the pivot pin 15, and a washer 20 can also be provided.

The fastening block 17 here has four screw holes 21 by means of which it can be screwed to the footboard 1 (FIG. 1).

As a result, using the front wheels 3 and 4, the front axle 5 can be rotated about the pivot pin 15 so that the roller board can be steered.

In the embodiment in FIGS. 2 and 3, the effective rotational axes 23 of the front wheels 3 and 4 are arranged radially offset from the front axle 5 by spacers 22, which results in improved directional stability.

In the exemplary embodiment in FIG. 4, the pivot pin 15 is connected, as in the previous exemplary embodiments, to the front axle 5, which is inserted through the opening 16 in the pivot pin 15. The axes of rotation 23 of the wheels are also connected to the front axle 5 via the spacers 22.

In contrast to the exemplary embodiment in FIGS. 2 and 3, the holding block 14 is made entirely of resilient material. The pivot pin 15 is inserted vertically from above into the holding block 14 in the drawing plane of FIG. 14, and the front axle 5 is inserted perpendicular thereto through the holding block 14 and the opening 16 in the pivot pin 15. The resilient holding block 14 is coupled here to the fastening block 17 such that the pivot pin 15 can rotate together with the front axle 5 about the axis of the pivot pin 15 relative to the fastening block 17 within predetermined limits, which is ensured by the resilient properties of the holding block 14.

The aforementioned limitation of the rotation of the pivot pin 15 is accomplished by means of first and second disks 24 and 25 coupled to the pivot pin 15. The first disk 24 has a hexagon socket 26 that is placed on hexagon head 27 at an end region 28 of the pivot pin 15, so that the disk 24 is connected rotation-fast to the pivot pin 15. Furthermore, the disk 24 has a plurality of radially outwardly projecting limit stops 29 that cooperate with counter-stops 30 of the second disk 25, the two disks 24 and 25 being disposed in a common plane when assembled. The second disk 25 has on its outer circumference a plurality of indentations 31 that interact with projections 32 inside the fastening block 17, so that the second disk 25 cannot rotate relative to the fastening block 17. As a result of this arrangement, the pivot pin 15 can only rotate within a limited range relative to the fastening block 17, since the projections 29 are limited in their direction of rotation by the counter-stops 30 of the second disk 25.

The first disk 24 is arranged in the interior of the second disk 25, which has radially inwardly projecting limit stops 30 that limit a relative rotation of the first disk 24 together with the pivot pin 15. The second disk 25 is in turn held non-rotatably in the fastening block 17 in that the former has recesses 31 on its outer circumference in which radially projecting projections 32 engage in the interior of the fastening block 17.

For more precise guidance of the pivot pin 15, a sleeve 33 is also provided and is attached to an end 28 of the pivot pin 15 that faces the fastening block 17 and that has a smaller diameter than the rest of the pivot pin 15. The sleeve 33 is slotted in the axial direction and thus also acts as a resilient mounting for the end of the pivot pin 15 in the fastening block 17.

On its side facing the fastening block 17 the holding block 14 has a cylindrical projection 33 which engages in the fastening block 17. On the outer circumference of the cylindrical projection 33 there are a plurality of recesses 34 that are oriented inward radially and axially and that are aligned with the projections 32 of the fastening block 17, so that the end of the holding block 14 facing the fastening block 17 is fixed there. Since the holding block 14 is made of resilient material, on the one hand it allows the rotational axis 5 to be rotated relative to the fastening block 17 about the axis of the pivot pin 15 within the ranges defined by the limit stops 29 and 30, and on the other hand, due to its resilient properties, it effects a restoring force for straight-ahead travel.

In summary, the invention proves a particularly simple and stable steering device that also enables very small radii of curvature, can be actuated with little effort, and returns dynamically and smoothly after deflection to the starting position for straight-ahead travel.

1. A roller board comprising a footboard, at least one rear wheel, and two steerable front wheels that are mounted on a front axle , the front axle being connected to the footboard via a pivot pin , wherein the front axle is rotatably coupled to the footboard in a resilient manner.

2. The roller board according to claim 1, wherein the resilient coupling between the front axle and the footboard occurs using a resilient holding block (that partially surrounds the front axle and the pivot pin, and that is connected with one end in a rotationally fixed manner to a fastening block, the fastening block being connected to the footboard.

3. The roller board according to claim 2, wherein the rotation of the pivot pin is limited using a disk having projections that is coupled to the pivot pin, and that is arranged inside a second disk connected rotation-fast to the fastening block, wherein the second disc has projections as a rotation limit stop and is connected rotation-fast to the fastening block.

4. The roller board according to claim 1, wherein the resilient coupling is accomplished using a resilient pivot pin, one end of which is connected rotation-fast to the front axle and the other end of which is connected rotation-fast to a fastening block, the fastening block being connected to the footboard.

5. The roller board according to claim 4, wherein the fastening block is rotatably mounted relative to a holding block, the fastening block and the holding block being connected to one another by means of the resilient pivot pin.

6. The roller board according to claim 4, wherein the resilient pivot pin is connected rotation-fast to the front axle in that the front axle is designed as a rod that is inserted through a hole in the pivot pin.

7. The roller board according to claim 6, wherein the pivot pin is fastened to the fastening block with a screw.
